(19) United States
(12) Patent Application Publication
(10) Pub. No.: US 2023/0029233 A1
(43) Pub. Date: Jan. 26, 2023

(54) INDOOR LOCALIZATION USING WLAN

(71) Applicant: Joseph SEOK, Cupertino, CA (US)

(72) Inventor: Joseph SEOK, Cupertino, CA (US)

(21) Appl. No.: 17/385,641

(22) Filed: Jul. 26, 2021

(51) Int. Cl. H04L 29/08; H04W 4/021

(52) U.S. Cl. CPC H04L 67/146; H04W 4/021; H04W 84/12

(57) ABSTRACT

A method performed by a transmitting station includes selecting a type of a management frame, generating the management frame according to the selected type of the management frame, the management frame including a dialog token, transmitting the management frame to a first receiving station, and receiving a response frame from a second receiving station as a response to the management frame. When a first type of the management frame is selected, a value of the dialog token is selected to uniquely identify the management frame on single receiving station. When a second type of the management frame is selected, a value of the dialog token is selected to uniquely identify the management frame on a plurality of receiving stations.

### BACKGROUND

### Field

The present invention relates to wireless communication and, more particularly, to a method and device for indoor localization using a wireless local area network.

### Related Art

The wide-scale proliferation of smart phones and wearable devices with wireless communication capabilities have made the localization and tracking of such devices synonym to the localization and tracking of the corresponding users and enabled a wide range of related applications and services. User and device localization have wide-scale applications in health sector, industry, disaster management, building management, surveillance and a number of various other sectors. Indoor localization is the process of obtaining a device or user location in an indoor setting or environment.

The Global Position System (GPS) is the first commercialized localization service, in which the user receives coordinate signals involving latitude and longitude from satellites. Using the time of flight, the distance to each satellite is calculated, before it is used to determine the user's position according to trilateration. However, due to satellite signals' difficulty in penetrating obstructions, GPS technology cannot be reliably used in indoor environments.

The received signal strength (RSS) based approach is one of widely used approaches for indoor localization. The RSS is the actual signal power strength received at the receiver, usually measured in decibel-milliwatts (dBm) or milliWatts (mW). The RSS can be used to estimate the distance between a transmitter (Tx) and a receiver (Rx) device; the higher the RSS value the smaller the distance between Tx and Rx. RSS based localization requires trilateration or N-point lateration, i.e., the RSS at the device is used to estimate the absolute distance between the user device and at least three reference points; then basic geometry/trigonometry is applied for the user device to obtain its location relative to the reference points.

A major limit of the indoor localization service is that an infrastructure that can provide the positioning mechanism has to be deployed. However, such infrastructure is not well commercialized. Even though some infrastructures have been deployed, it is difficult to use their localization service due to them not being standardized.

### SUMMARY

An objective of the present disclosure is to develop an indoor localization system using a wireless local area network (WLAN).

Another objective of the present disclosure is to develop multi-link management procedure using WLAN.

In an aspect, a method for communication in a wireless local area network is provided. The method performed by a transmitting station includes selecting a type of a management frame, generating the management frame according to the selected type of the management frame, the management frame including a dialog token, transmitting the management frame to a first receiving station, and receiving a response frame from a second receiving station as a response to the management frame. When a first type of the management frame is selected, a value of the dialog token is selected to uniquely identify the management frame on single receiving station. When a second type of the management frame is selected, a value of the dialog token is selected to uniquely identify the management frame on a plurality of receiving stations.

In another aspect, a device for communication in a wireless local area network includes a processor, and a memory operatively coupled with the processor and configured to store instructions that, when executed by the processor, cause the device to perform functions comprising selecting a type of a management frame, generating the management frame according to the selected type of the management frame, the management frame including a dialog token, transmitting the management frame to a first receiving station, and receiving a response frame from a second receiving station as a response to the management frame. When a first type of the management frame is selected, a value of the dialog token is selected to uniquely identify the management frame on single receiving station. When a second type of the management frame is selected, a value of the dialog token is selected to uniquely identify the management frame on a plurality of receiving stations.

In still another aspect, a method for communication in a wireless local area network is provided. The method performed by a transmitting station includes selecting a first dialog token and a second dialog token, transmitting a first management frame to a first station through a first operating channel, the first management frame including the first dialog token, and transmitting a second management frame to a second station through a second operating channel, the second management frame including the second dialog token. The first and second dialog tokens are selected to uniquely identify the first and second management frames.

### BRIEF DESCRIPTION OF THE DRAWINGS

FIG. 1 is a diagram illustrating an embodiment of a wireless communication system.

FIG. 2 is a diagram illustrating a fine timing measurement protocol.

FIG. 3 is a diagram illustrating distance measurements based on FTM.

FIG. 4 is a graph showing positioning errors according to experiment results.

FIG. 5 is a diagram illustrating a method for communication according to an embodiment of the present disclosure.

FIG. 6 is a diagram illustrating a format of a FTM request frame according to an embodiment of the present disclosure.

FIG. 7 is a diagram illustrating a format of a FTM frame according to an embodiment of the present disclosure.

FIG. 8 is a diagram illustrating a method for communication according to another embodiment of the present disclosure.

FIG. 9 is a diagram illustrating a method for communication according to still another embodiment of the present disclosure.

### DESCRIPTION OF EXEMPLARY EMBODIMENTS

The embodiments of the present disclosure may be practiced in a variety of wireless communication devices that operate in a wireless network. The examples described herein pertain to devices that operate utilizing current wireless local area network (WLAN)-based technology, such as the 2.4 GHz or 5 GHz Bands that encompass current WLAN protocols, as well as developing WLAN-based technology, such as the newer 60 GHz standard in the 60 GHz band, being developed by the Wireless Gigabit Alliance (WiGig) and Institute of Electrical and Electronics Engineers (IEEE). However, the present disclosure need not be limited to one particular WLAN technology and may be readily adapted for other frequencies, protocols and standards. For example, the present disclosure may be readily adapted to utilize the Bluetooth™ protocol or mobile networks develop by 3rd Generation Partnership Project (3GPP).

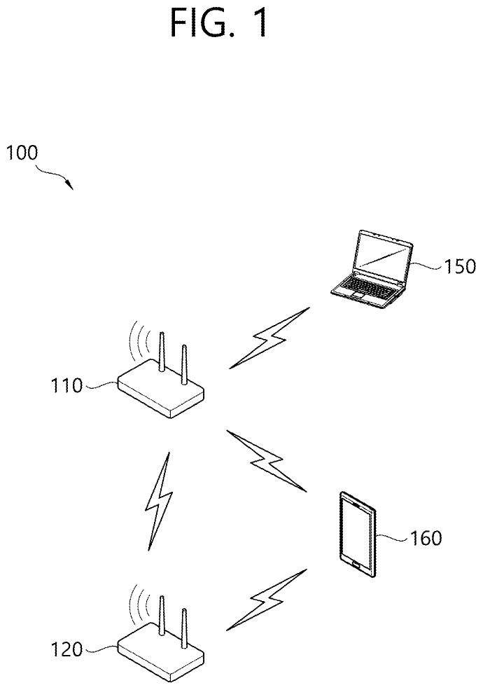

FIG. 1 is a diagram illustrating an embodiment of a wireless communication system.

A wireless communication system 100 includes access points (APs) 110-120, and wireless communication devices 150-160. The wireless communication devices 150-160 may be laptop computers, tablets, personal digital assistants, personal computers and/or cellular telephones. Other examples of such wireless communication devices 150-160 could also or alternatively include other types of devices that include wireless communication capability.

The APs 110-120 may be referred to as base stations and are operably coupled to local area network connections. Each of the APs 110-120 has an associated antenna or antenna array to communicate with the wireless communication devices in its area. Typically, the wireless communication devices register with a particular AP to receive services from the communication system 100. For direct connections (i.e., point-to-point communications), wireless communication devices communicate directly via an allocated channel.

Any of the various wireless communication devices 150-160 and APs 110-120 may include a processor and/or a communication interface to support communications with any other of the wireless communication devices 150-160 and APs 110-120. In an example of operation, a processor and/or a communication interface implemented within one of the devices (e.g., any one of the wireless communication devices 150-160 and APs 110-120) is/are configured to process at least one signal received from and/or to generate at least one signal to be transmitted to another one of the devices (e.g., any other one of the wireless communication devices 150-160 and APs 110-120).

Note that general reference to a communication device, such as the wireless communication devices 150-160 and APs 110-120 in FIG. 1, or any other communication devices and/or wireless communication devices may alternatively be made generally herein using the term ‘station (STA) or ‘wireless device’. For example, with respect to FIG. 1, “AP 110” may be referred to the “STA 110, or “wireless communication device 150” may be referred to “STA 150”.

A station (STA) may be any type of one or more wireless communication device types including the wireless communication devices 150-160 and/or APs 110-120. The APs or AP-operative STAs may be any type of one or more wireless communication devices including as APs 110-120. Different groups of the wireless communication devices 150-160 may be partitioned into different basic services sets (BSSs). In some instances, at least one of the wireless communication devices 150-160 are included within at least one overlapping basic services set (OBSS) that cover two or more BSSs. As described above with the association of the wireless communication devices in an AP-STA relationship, one of the wireless communication devices may be operative as an AP and certain of the wireless communication devices 150-160 can be implemented within the same basic services set (BSS).

A STA (e.g., any one of the wireless communication devices 150-160 and APs 110-120) includes a communication interface, a memory and/or a processor (and possibly other possible circuitries, components, elements, etc.) to support communications with other STA(s) and to generate and process signals for such communications. The communication interface, the memory and/or the processor operate to perform various operations and functions to effectuate such communications (e.g., the communication interface and the processor may be configured to perform certain operation(s) in conjunction with one another, cooperatively, dependently with one another, etc. and other operation(s) separately, independently from one another, etc.). The memory may store instructions to execute various operations including interpreting at least one signal, symbol, packet, and/or frame transmitted to wireless communication device 100 and/or received from the wireless communication device 100 and/or another STA. In some examples, such a processor includes all capability, functionality, and/or circuitry, etc. to perform such operations as described herein. In some examples, such a memory includes all capability, functionality, and/or circuitry, etc. to perform such operations as described herein. In some other examples, such a communication interface includes all capability, functionality, and/or circuitry, etc. to perform such operations as described herein. In even other examples, such a processor, a memory and a communication interface include all capability, functionality, and/or circuitry, etc. to perform such operations as described herein, at least in part, cooperatively with one another.

Some examples of possible STAs that may be implemented to operate in accordance with any of the various examples, embodiments, options, and/or their equivalents, etc. described herein may include, but are not limited by, appliances within homes, businesses, etc. such as refrigerators, microwaves, heaters, heating systems, air conditioners, air conditioning systems, lighting control systems, and/or any other types of appliances, etc.; meters such as for natural gas service, electrical service, water service, Internet service, cable and/or satellite television service, and/or any other types of metering purposes, etc.; devices wearable on a user or person including watches, monitors such as those that monitor activity level, bodily functions such as heartbeat, breathing, bodily activity, bodily motion or lack thereof, etc.; medical devices including intravenous medicine delivery monitoring and/or controlling devices, blood monitoring devices (e.g., glucose monitoring devices) and/or any other types of medical devices, etc.; premises monitoring devices such as movement detection/monitoring devices, door closed/ajar detection/monitoring devices, security/alarm system monitoring devices, and/or any other type of premises monitoring devices; multimedia devices including televisions, computers, audio playback devices, video playback devices, and/or any other type of multimedia devices, etc.; vehicles such as automobiles, ships and/or any other type of transportation devices; and/or generally any other type(s) of device(s) that include(s) wireless communication capability, functionality, circuitry, etc. In general, any device that is implemented to support wireless communications may be implemented to operate in accordance with any of the various examples, embodiments, options, and/or their equivalents, etc. described herein.

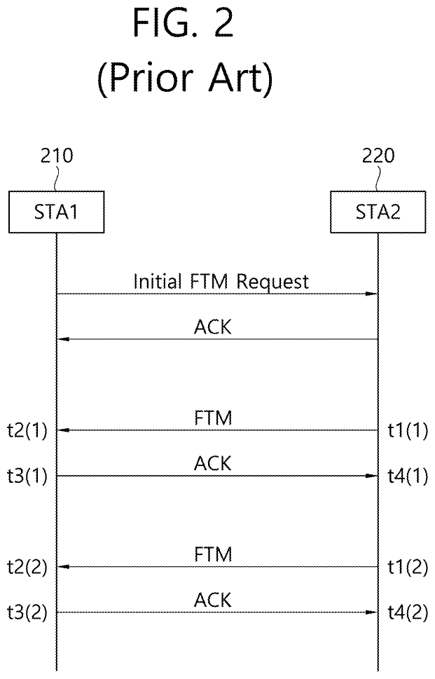

FIG. 2 is a diagram illustrating a fine timing measurement protocol. The fine timing measurement (FTM) protocol may refer to section 11.24.6 of IEEE 802.11-2016 specification.

The FTM protocol is used to estimate a distance between STA1 210 and STA2 220. STA1 210 is an initiating STA that initiates the FTM process by sending a FTM Request to STA2 220. STA2 220 is a responding STA. Based on the STA2 220 response, the protocol agrees or refuses to continue the FTM process. In the case of agreement, the STA2 220 starts to send a FTM frame and wait for its ACK. The round trip time (RTT) is estimated based on the transmission timestamp of the FTM frame and the reception timestamp of its ACK. The STA2 220 may send multiple FTM frames, but have to wait for acknowledgement, before sending a new FTM frame. FIG. 2 shows an example of one burst with 2 FTM frames. The RTT is calculated for n FTM frames within one burst as follows:

RTT=1/n(Σₖ₌₁ⁿt4(k)−Σₖ₌₁ⁿt1(k))−1/n(Σₖ₌₁ⁿt3(k)−Σₖ₌₁ⁿt2(k))

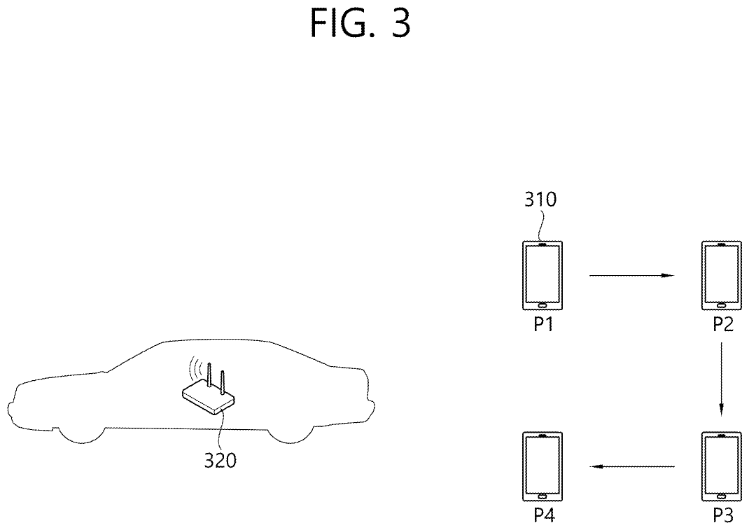

FIG. 3 is a diagram illustrating distance measurements based on FTM.

STA1 310 is a mobile phone carried by a user. STA2 320 is installed in an automobile which is parked. STA2 320 may be an AP.

STA 310 moves through four pre-determined points (P1, P2, P3, P4) in an indoor environment. STA 310 and STA 320 can execute FTM procedure at each point and STA 310 performs the trilateration algorithm in order to determine the direction and distance to the automobile of STA 320. and STA 310 records FTM-based distance measurements.

Depending on the accuracy of the distance measurement between STA1 310 and STA 320, the positioning errors between the measurement points may vary. An usual accuracy of the FTM distance measurement is one meter.

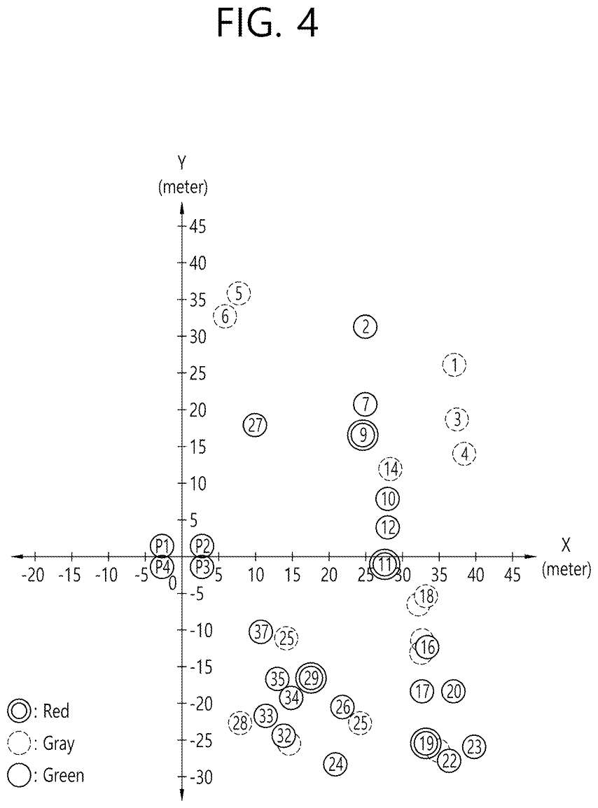

FIG. 4 is a graph showing positioning errors according to experiment results.

Four points (P1, P2, P3, P4) represent 4.87 meter×2.74 meter square. Number in circles denotes measurement points. User moves from the measurement point 1 to the measurement point 40. At each measurement point, distances to an automobile are measured at four points (P1, P2, P3, P4) using FTM procedure.

Green, Red and Gray circles show the estimated position errors of the automobile as the user moves. Green circles represent that positioning errors are less than 5 meter. Red circles represent that positioning errors are between 5 meter and 10 meter. Gray circles represent that positioning errors are greater than 10 meter.

Near the start of the traversal through a parking lot, a wall intercepts the line of sight between the user and the automobile. The accuracy of the FTM distance measurements was low and high positioning errors of the automobile are observed. After passing the wall, a direct line of sight between the user and the automobile is established. The accuracy of the FTM distance measurements was stably high and reliable positioning errors of the automobile are observed. As the distance between the measurement points increases, the accuracy of the automobile positioning increases.

WiFi is an ideal candidate for indoor localization. However, the conventional FTM measurement just ensures at least one meter-accuracy. It is proposed to achieve higher accuracy for indoor localization.

Hereinafter, a requesting STA is a STA to estimate a position of one or more responding STAs. The requesting STA may be mobile, but the responding STA may be stationary. The requesting STA may be an initiating STA of a FTM protocol and the responding STA may be a responding STA of the FTM protocol.

There are a plurality of responding STAs to perform FTM protocol concurrently or non-concurrently with one requesting STA. The plurality of responding STAs may include logical STAs and/or physical STAs. Two physical STAs means that the two STAs are separated physically and may have different MAC addresses. Two logical STAs means that the two STAs are separated logically within one physical STA. For example, two logical STAs denotes one operating band with 2.4 GHz and another operating band with 5 GHz within one AP.

The plurality responding STAs may satisfy at least one of following conditions: (i) different BSSIDs (ii) different MAC addresses, (iii) different operating channels, and different operating bands. The plurality of responding STAs may be referred to as various expressions such as a plurality of links, a plurality of channels, a plurality of BSSs, a plurality of APs, etc.

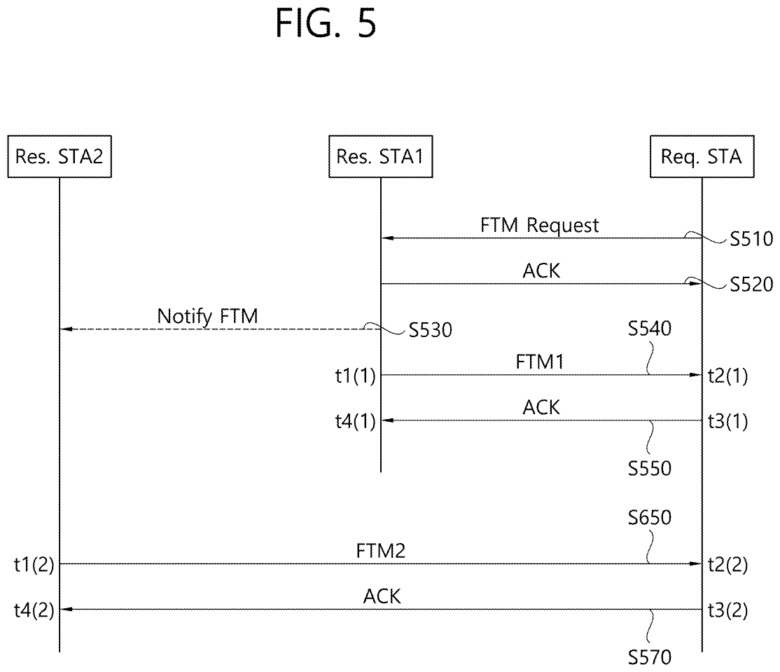

FIG. 5 is a diagram illustrating a method for communication according to an embodiment of the present disclosure. For clarity, two responding STAs are shown, but the number of responding STAs is not limited.

In step S510, a requesting STA sends a FTM request frame for requesting multiple FTM processes with multiple responding STAs to a responding STA1. In this example, the FTM request frame includes information on a responding STA2 which perform FTM process.

In step S520, the responding STA1 sends an ACK to accept the request of the FTM protocol.

In step S530, the responding STA1 can notify the responding STA2 to start the transmission of FTM frame.

In step S540, the responding STA1 sends a first FTM frame to the requesting STA. In step S550, the requesting STA sends a first ACK frame as a response to the first FTM frame.

The first FTM frame includes a first timestamp that represents the time at which the start of the last transmitted FTM frame. The first FTM frame may further include a second timestamp that represents the time at which the start of the ACK frame to the last transmitted FTM frame arrived. The first FTM frame may include a dialog token field that is set to a nonzero value chosen by the responding STA1 to identify a corresponding FTM frame and ACK frame exchange sequence.

In step S560, the responding STA2 sends a second FTM frame to the requesting STA. In step S570, the requesting STA sends a second ACK frame as a response to the second FTM frame.

The second FTM frame includes a first timestamp that represents the time at which the start of the last transmitted FTM frame. The second FTM frame may further include a second timestamp that represents the time at which the start of the ACK frame to the last transmitted FTM frame arrived. The second FTM frame may include a dialog token field that is set to a nonzero value chosen by the responding STA2 to identify a corresponding FTM frame and ACK frame exchange sequence. The second FTM frame may include a follow up dialog token field that has a value of the dialog token filed of the last transmitted FTM frame to indicate that it is the follow up FTM frame. In this example, the follow up dialog token field of the second FTM frame is set to a value of the dialog token field of the first FTM frame.

There is no restriction in sequence of performing multiple FTM processes. The responding STA2 firstly sends a FTM frame before the responding STA1 sends a FTM frame. Alternatively, the responding STA1 and the responding STA2 perform FTM process concurrently. Both the responding STA1 and the responding STA2 may send FTM frames simultaneously. The responding STA2 may send its FTM frame while the responding ST1 sends a FTM frame.

The dialog tokens of FTM frame are used to identify a pair of FTM frame-ACK frame. Therefore, the first dialog token of the first FTM frame should be different from the second dialog token of the second FTM frame. The responding STA1 and responding STA2 should choose unique values as dialog tokens. When multiple FTM processes are performed, the value of dialog token is chosen to identify uniquely the FTM frame over multiple responding STAs.

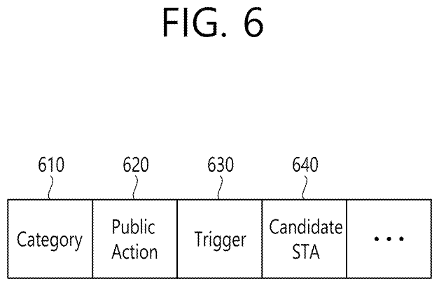

FIG. 6 is a diagram illustrating a format of a FTM request frame according to an embodiment of the present disclosure.

The FTM request frame may include a category field 610, a public action field 620, a trigger field 630 and a candidate STA field 640.

The category field 610 provides a mechanism for specifying management actions. The public action field 620 defines inter-BSS communications or intra-BSS communications.

The trigger field 630 may be set to a first value (e.g. 2) to indicate that the requesting STA requests the multiple FTM processes with multiple responding STAs. The trigger field 630 may be set to a second value (e.g. 1) to indicate that the requesting STA requests one FTM process with one responding STA. The trigger field 630 may be set to a third value (e.g. 0) to indicate that the requesting STA requests that the responding STA stop sending FTM frames.

The candidate STA field 640 indicates one or more candidate responding STAs when the multiple FTM processes with multiple responding STAs are requested. In the example shown in FIG. 5, the candidate STA field 640 may indicate the responding STA2.

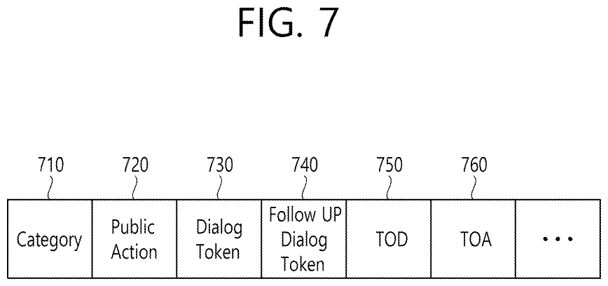

FIG. 7 is a diagram illustrating a format of a FTM frame according to an embodiment of the present disclosure.

The FTM frame may include a category field 710, a public action field 720, a dialog token field 730, a follow up dialog token field 740, a time of departure (TOD) field 750 and a time of arrival (TOA) field 760.

The category field 710 provides a mechanism for specifying management actions. The public action field 720 defines inter-BSS communications or intra-BSS communications.

The dialog token field 730 is a nonzero value chosen by the responding STA to identify the corresponding FTM frame and ACK frame exchange sequence. The dialog token field is set to specific value (e.g. 0) to indicate the end of the FTM process. As discussed above, the dialog token field 730 may be set to an unique value over the multiple FTM processes or multiple STAs.

The follow up dialog token field 740 is the nonzero value of the dialog token field of the last transmitted FTM frame to indicate that it is the follow up FTM frame and that the TOD field 750 and the TOA field 760 contain the values of the timestamps captured with the first FTM frame of the pair. The follow up dialog token field 740 may be set to specific value (e.g. 0) to indicate that the FTM frame is not a follow up to a last transmitted FTM frame.

The TOD field 750 contains a timestamp that represents the time, with respect to a time base, at which the start of the last transmitted FTM frame appered.

The TOA field 760 contains a timestamp that represents the time, with respect to a time base, at which the start of the ACK frame to the last transmitted FTM frame arrived.

A dialog token is an integer value that assists a STA in grouping management frames sent or received at different times as part of the same dialog. The value of the dialog token needs to be selected to minimize the probability of a frame associated with one dialog being incorrectly associated with another dialog.

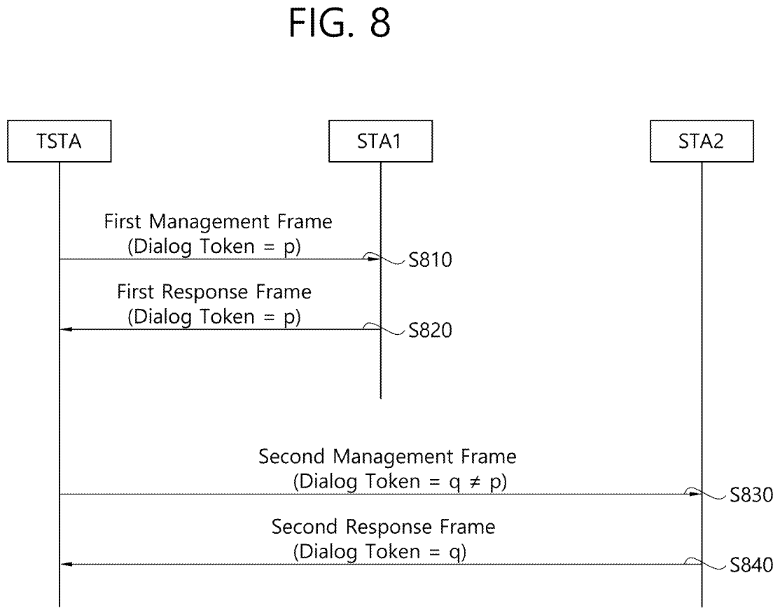

FIG. 8 is a diagram illustrating a method for communication according to another embodiment of the present disclosure.

In step S810, transmitting STA (TSTA) transmits a first management frame to STA1. In step S820, TSTA receives a first response frame from STA1 as a response to the first management frame. In step S830, TSTA transmits a second management frame to STA2. In step S840, TSTA receives a second response frame from STA2 as a response to the second management frame.

The first and second management frames may include an association request frame, a link measurement frame and/or a FTM request frame. The first and second response frames may include an association response frame, a link measurement result frame and/or a timing measurement frame. The timing measurement frame may contain information (e.g. a TOA field and a TOD field) that represents the time of arrival of a first frame and the time of departure of a second frame respectively (e.g., FTM frame).

TSTA may determine measurement/management parameters to perform the multi-link/multi-radio measurement/management procedure. TSTA may be a non-AP STA. STA1 and STA2 may be logical APs or physical APs. For example, when STA1 and STA2 are logical APs, STA1 and STA2 may be two operating channels in on physical AP. When STA1 and STA2 are physical APs, STA1 and STA2 have different MAC addresses. STA1 may be a member of a first BSS and STA2 may be a member of a second BSS. The first and second BSSs are managed by TSTA or an AP.

TSTA may transmit the first management frame through a first operating channel and transmit the second management frame through a second operating channel. The first and second operating channels are operated in one of 2.4 GHz band, 5 GHz band and 60 GHz band. The first operating channel ha different frequency band from the second operating channel.

The first management frame includes a first dialog token, and the second management frame includes a second dialog token. A corresponding response frame may include a corresponding dialog token. TSAT can select the dialog token values to uniquely identify the corresponding measurement/management exchange sequence.

STA1 or STA2 can send the response frames of the first and second management frame on any link/radio channel. For example, STA2 can transmit the first response frame though the second operating channel, and STA1 can transmit the second response frame through the first operating channel. Alternatively, STA2 can transmit the first response frame though the first operating channel, and STA1 can transmit the second response frame through the second operating channel.

A value of the dialog token is determined to assist in grouping management frames sent or received on multiple STAs at different times as part of the same dialog.

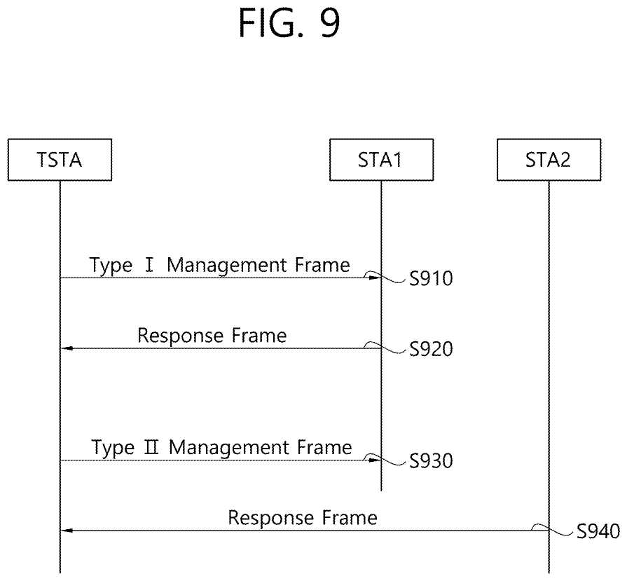

FIG. 9 is a diagram illustrating a method for communication according to still another embodiment of the present disclosure.

TSTA determines a type of a management frame: a first type of management frame (type I management frame) or a second type of management frame (type II management frame). The type I management frame has a dialog token to uniquely identify the corresponding measurement/management exchange sequence with single STA. The type II management frame has a dialog token to uniquely identify the corresponding measurement/management exchange sequence with more than one STA.

In step S910, TSTA transmits the type I management frame to STA1. In step S920, TSTA receives a response frame from STA1 as a response to the type I management frame. Since type I management frame uniquely identifies the management exchange sequence with single STA, STA1 should respond to the type I management frame.

In step S930, TSTA transmits the type II management frame to STA1. In step S940, TSTA receives a response frame from STA2 as a response to the type II management frame. Since type II management frame uniquely identifies the management exchange sequence with more than one STA, STA1 or STA2 can respond to the type II management frame. If STA1 instructs STA2 to respond to the type II management frame, STA2 can send the response frame.

TSTA may be a non-AP STA. STA1 and STA2 may be logical APs or physical APs. For example, when STA1 and STA2 are logical APs, STA1 and STA2 may be two operating channels in on physical AP. When STA1 and STA2 are physical APs, STA1 and STA2 have different MAC addresses. STA1 may be a member of a first BSS and STA2 may be a member of a second BSS. The first and second BSSs are managed by TSTA or an AP.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the claimed invention.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof

What is claimed is:

1. A method for communication in a wireless local area network, the method performed by a transmitting station and comprising:
selecting a type of a management frame;
generating the management frame according to the selected type of the management frame, the management frame including a dialog token;
transmitting the management frame to a first receiving station; and
receiving a response frame from a second receiving station as a response to the management frame,
wherein:
when a first type of the management frame is selected, a value of the dialog token is selected to uniquely identify the management frame on single receiving station, and
when a second type of the management frame is selected, a value of the dialog token is selected to uniquely identify the management frame on a plurality of receiving stations.

2. The method of claim 1, wherein, when the second type of the management frame is selected, the second station is different from the first station.

3. The method of claim 1, wherein, when the first type of the management frame is selected, the second station and the first station are same station.

4. The method of claim 1, wherein the first and second stations are logical stations within one access point.

5. The method of claim 4, wherein the first receiving station corresponds to a first operating channel being operated in 2.4 GHz band and the second receiving station corresponds to a second operating channel being operated in 5 GHz band.

6. A device for communication in a wireless local area network, the device comprising:
a processor; and
a memory operatively coupled with the processor and configured to store instructions that, when executed by the processor, cause the device to perform functions comprising:
selecting a type of a management frame;
generating the management frame according to the selected type of the management frame, the management frame including a dialog token;
transmitting the management frame to a first receiving station; and
receiving a response frame from a second receiving station as a response to the management frame,
wherein:
when a first type of the management frame is selected, a value of the dialog token is selected to uniquely identify the management frame on single receiving station, and
when a second type of the management frame is selected, a value of the dialog token is selected to uniquely identify the management frame on a plurality of receiving stations.

7. The device of claim 1, wherein, when the second type of the management frame is selected, the second station is different from the first station.

8. The device of claim 6, wherein, when the first type of the management frame is selected, the second station and the first station are same station.

9. The device of claim 6, wherein the first and second stations are logical stations within one access point.

10. The device of claim 9, wherein the first receiving station corresponds to a first operating channel being operated in 2.4 GHz band and the second receiving station corresponds to a second operating channel being operated in 5 GHz band.

11. A method for communication in a wireless local area network, the method performed by a transmitting station and comprising:
selecting a first dialog token and a second dialog token;
transmitting a first management frame to a first station through a first operating channel, the first management frame including the first dialog token; and
transmitting a second management frame to a second station through a second operating channel, the second management frame including the second dialog token,
wherein the first and second dialog tokens are selected to uniquely identify the first and second management frames.

12. The method of claim 11, wherein the first operating channel is operated in 2.4 GHz band and the second operating channel is operated in 5 GHz band.

13. The method of claim 11, wherein the first operating channel is operated in one of 2.4 GHz band, 5 GHz band and 60 GHz band, and the second operating channel is operated in one of 2.4 GHz band, 5 GHz band and 60 GHz band.

14. The method of claim 11, wherein the first station is a member of a first basic service set (BSS), and the second station is a member of a second BSS.

15. The method of claim 11, wherein the transmitting station is a non-access point station.
